(19) United States
(12) Patent Application Publication
(10) Pub. No.: US 2004/0157544 A1
(43) Pub. Date: Aug. 12, 2004

(54) Home network system

(76) Inventors: Kyeong Ho Moon, Changwon-si (KR); Seong Jin Jo, Changwon-si (KR)

Correspondence Address: BIRCH STEWART KOLASCH & BIRCH, PO BOX 747, FALLS CHURCH, VA, 22040-0747, US

(21) Appl. No.: 10/720,347

(22) Filed: Nov. 25, 2003

(30) Foreign Application Priority Data
Nov. 25, 2002 (KR) P2002-0073500
Nov. 25, 2002 (KR) P2002-0073501
Nov. 25, 2002 (KR) P2002-0073502

(51) Int. Cl. H04H 1/00

(52) U.S. Cl. 455/3.01

(57) ABSTRACT

A home network system is disclosed, in which a home server is communicated with home appliances by wireless, thereby controlling the home appliances effectively. The home network system includes a home server controlling home appliances; a first wireless communication means connected to the home server; and a second wireless communication means connected to the home appliances, communicating with the first wireless communication means. Accordingly, it is not required to provide cables for communication between the home server and the home appliances, whereby it is possible to decrease limitations in a communication range between the home server and the home appliances, and to freely change positions of the home appliances.

This application claims the benefit of the Korean Application Nos. P2002-73500, P2002-73501 and P2002-73502 filed on Nov. 25, 2002, which is hereby incorporated by reference.

### BACKGROUND OF THE INVENTION

1. Field of the Invention

The present invention relates to a home network system, and more particularly, to a home network system, in which a home server is communicated with home appliances by wireless.

2. Discussion of the Related Art

In general, a home network system is an automatic control system that constructs a home server having an Internet communication function to control home appliances. That is, a user can control the home appliances within home by the home server. Even though the user is at a distance from home, the user performs the contact with the home server so as to control the home appliances within home.

FIG. 1 is a home network system illustrating a related art home network system. Referring to FIG. 1, the related art home network system includes an external input means 1, a home server 2 and home appliances 3. At this time, the external input means I transmits a control command of a user to the external, and the home server 2 is connected to a web server in order to receive and output the control command from the external input means 1. Then, the home appliances 3 receiving the control command outputted from the home server 2 are operated according to the corresponding control command.

In this case, the home server 2 is connected to the home appliances 3 by wire. That is, the respective home appliances 3 are connected to the home server 2 by cables, whereby the home appliances 3 are controlled by the control command outputted from the home server 2, or the control command transmitted from the external through the home server 2.

Accordingly, the related art home network system has the following disadvantages.

In the related art home network system, the home appliances are connected to the home server, centralized control system for controlling the home appliances, by the cables. Thus, if there are the various home appliances, it requires a large amount of cables connecting the home server with the home appliances. Also, whenever the position of the home appliance is changed, it is necessary to control the length of the cable. Further, in case of the home server is at a distance from the home appliances, it has the problems in connecting the home server with the home appliances.

### SUMMARY OF THE INVENTION

Accordingly, the present invention is directed to a home network system that substantially obviates one or more problems due to limitations and disadvantages of the related art.

An object of the present invention is to provide a home network system, in which a home server is communicated with home appliances by wireless, thereby controlling the home appliances effectively.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a home network system includes a home server controlling home appliances; a first wireless communication means connected to the home server; and a second wireless communication means connected to the home appliances, communicating with the first wireless communication means.

At this time, the home server displays a select screen showing functions of the home appliances, and provides the select screen to an external terminal. Also, the home server stores a record regarding operations of the home appliances, the record including a driving time and mode of the home appliance, and power consumption. In addition, the home server has a reservation function of operating the home appliance at a preset time.

The home server is connected with the first wireless communication means by cable, and the home appliances are connected with the second wireless communication means by cable. The home server controls a channel of the first wireless communication means, and the second wireless communication means respectively connected to the home appliances have different channels. Also, the first wireless communication means is mounted inside the home server, and the second wireless communication means is mounted inside the home appliance.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating a related art home network system;

FIG. 2 is a block diagram illustrating a home network system according to the first embodiment of the present invention;

FIG. 3 is a block diagram illustrating a data structure of a control command;

FIG. 4 is a block diagram illustrating a home network system according to the second embodiment of the present invention; and

FIG. 5 is a block diagram illustrating a home network system according to the third embodiment of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

Hereinafter, a home network system according to the present invention will be described with reference to the accompanying drawings.

The home network system according to the present invention includes a home server for controlling home appliances within home when a user is inside or outside home. The home server is communicated with the home appliances by wireless, so as to control the home appliances. Thus, it is not required to provide cables for communication between the home server and the home appliances, whereby it is possible to decrease limitations in a communication range between the home server and the home appliances, and to freely change positions of the home appliances.

First embodiment

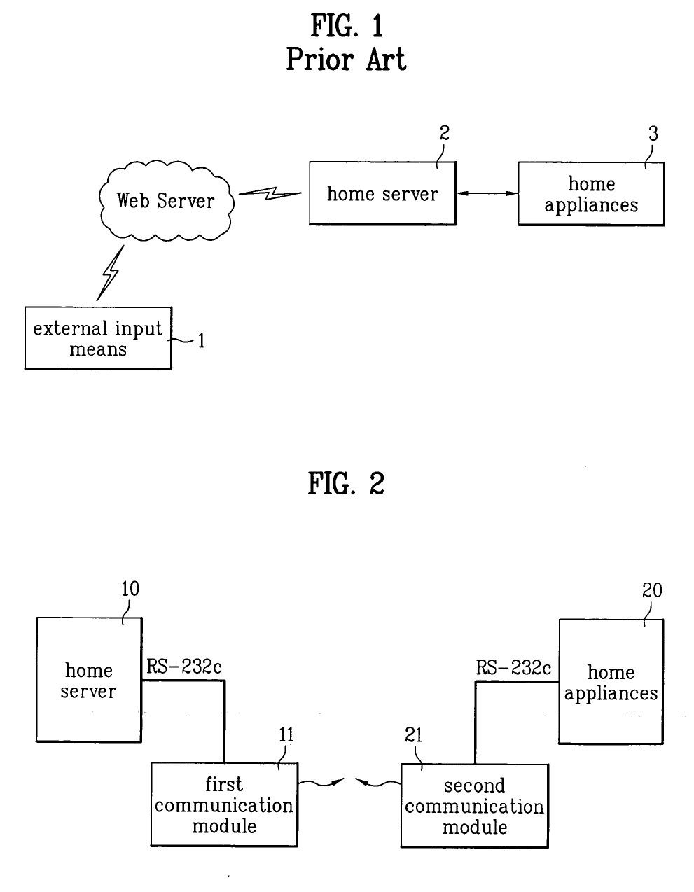

FIG. 2 is a block diagram illustrating a home network system according to the first embodiment of the present invention, showing a communication structure between a home server and home appliances.

As shown in FIG. 2, the home network system according to the first embodiment of the present invention includes a home server 10 communicating with a web server by an external communication network, and communicating with home appliances 20 within home. At this time, it is possible to substitute various communication devices communicating with the web server, for example, household PC, internet-refrigerator, internet-digital television and gateway for the home server 10. Also, the home server 10 includes a memory (not shown) storing various information such as communication recording between the home server 10 and the home appliances 20 and operation recording of the home appliances 20. Also, the home server 10 has a reservation function for operating a specific appliance at a preset time.

Under control of the home server 10, the home appliances 20 are operated, and then corresponding response signal and operation recording of the home appliances 20 are transmitted to the home server 10. For example, the operation recording includes information such as an operating time of a refrigerator, or a heating time and a temperature of a boiler.

For communication between the home server 10 and the home appliances 20, the home server 10 and the home appliances 20 are respectively connected with first and second communication modules 11 and 21, so that the first and second communication modules 11 and 21 are controlled respectively. In this case, the home server 10 is connected with the first communication module 11 by a wire such as RS-232C cable. Also, the home appliances 20 are connected with the second communication module 21 by a wire such as RS-232C cable.

The first and second communication modules 11 and 21 are modules for wireless communication. Thus, the home server 10 and the home appliances 20 are communicated with the first and second communication modules 11 and 21 by wireless. According to one preferred embodiment of the first and second communication modules 11 and 21, in case of that the first and second communication modules 11 and 21 are RF (Radio Frequency) communication modules, it is possible to transmit a signal in a large communication range between the first and second communication modules 11 and 21. As a result, it decreases limitations in the communication range between the home server 10 and the home appliances 20. The first and second communication modules 11 and 21 are combination master & slave communication modules. The combination master & slave communication modules have data transmission frequency bands of 300 MHz to 2.9 GHz. Also, the combination master & slave communication modules have both transmitting and receiving functions, and have RS-232C port so as to be connected with all terminals supporting RS-232C communication.

An operation of the home network system according to the first embodiment of the present invention will be described as follows.

First, a user performs the contact with the home server 10 so as to use or control the home appliances 20 within home. If the user is far from home, the user performs the contact with the home server 10 by Internet or wireless terminal in order to use or control the home appliances 20. For example, in case of that the user is in an office at a distance from home, the user performs the contact with the home server 10 by using IP address of the home server 10 with the terminal. Then, the home server 10 provides a select screen to the terminal, whereby the user can select the specific function of the home appliances 20. At this time, the select screen may be displayed on the terminal and a display part (not shown) of the home server 10. After that, the user selects the specific home appliance to be operated from the select screen, and the desired function of the selected home appliance. Also, the user may select the reservation function so as to operate the specific home appliance at the preset time. For this, the home server 10 displays a reservation screen, and the reservation screen is provided to the terminal of the user.

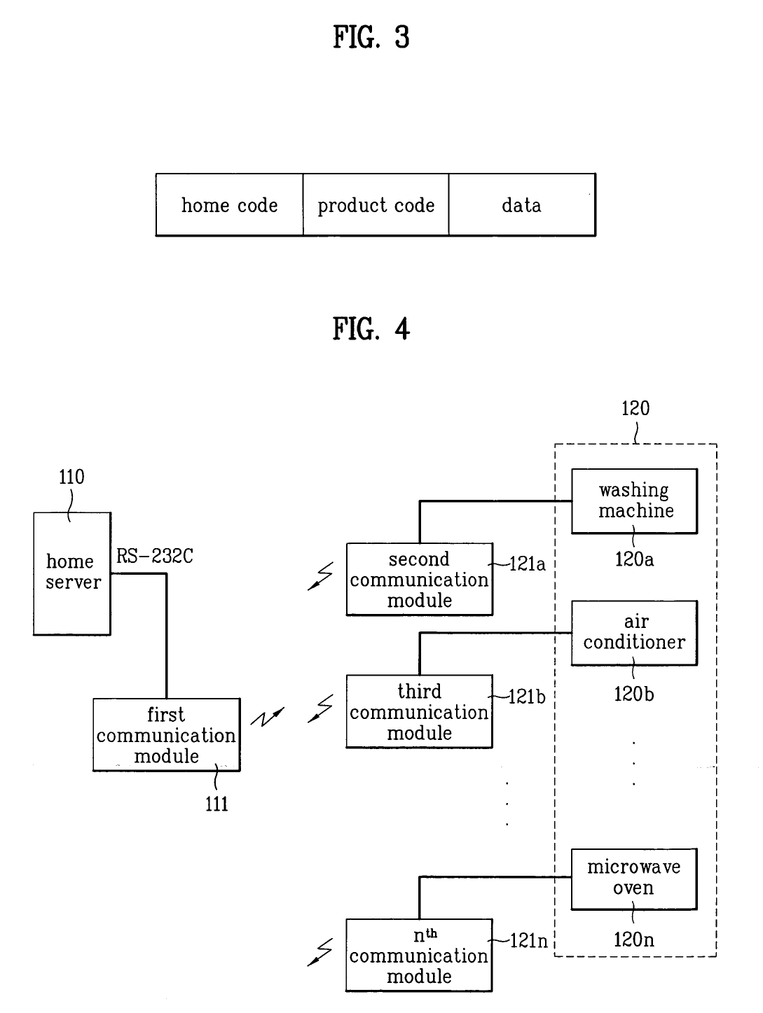

Under control of the user, the home server 10 transmits a control command to the first communication module 11 by the RS-232C cable. FIG. 3 illustrates the data structure of the control command, outputted from the home server 10. Referring to FIG. 3, the control command includes a home code, a product code and data. In this case, the home code is a peculiar code assigned to each user so as to prevent the data contact between adjacent neighbors, and the product code is a peculiar code assigned to each home appliance 20. Also, if the user selects the reservation function, the home server 10 transmits the corresponding control command to the first communication module 11 at the preset time.

Next, the first communication module 11 receives the control command from the home server 10, and then transmits the control command to the second communication module 21 by wireless. After that, the second communication module 21 inputs the control command to the home appliance 20 connected by the RS-232C cable, and a microprocessor (not shown) of the home appliance 20 identifies the home and product codes of the control command. Then, the microprocessor compares the home and product codes of the control command with the home and product codes stored in the home appliance 20. If the home and product codes of the control command are identical to those stored in the home appliance 20, the home appliance 20 performs the corresponding operation according to the control command. Meanwhile, the home and product codes of the control command are not identical to those stored in the home appliance 20, the home appliance 20 is not operated.

After the home appliance 20 is operated according to the control command, the information regarding the operation of the home appliance 20 is transmitted to the home server 20 by the second communication module 21 and the first communication module 11. For example, the information relates to an operation history of the home appliance 20, such as driving time and mode of the home appliance 20, power consumption and operation error. The information is displayed on the display part (not shown) of the home server 10, and stored in the memory (not shown) of the home server 10. Hence, in case of that the user operates the home appliance 20 again, the user can easily select the operation type including the preferred driving time and mode with the information stored in the memory.

Second embodiment

FIG. 4 is a block diagram illustrating a home network system according to the second embodiment of the present invention. As shown in FIG. 4, the home network system according to the second embodiment of the present invention includes a home server 110, a plurality of home appliances 120a, 120b, . . . 120n, a first communication module 110 connected to the home server 110 by wire, a plurality of communication modules 121a, 121b, . . . 121n respectively connected wit the home appliances 120a, 120b, . . . 120n by wire.

A structure and operation of the home network system according to the second embodiment of the present invention is similar to that of the home network system according to the first embodiment of the present invention. However, the first communication module 111 in the home network system according to the second embodiment of the present invention is different from the first communication module 11 in the home network system according to the first embodiment of the present invention. For example, the first communication module 111 in the home network system according to the second embodiment of the present invention is a multi-channel wireless communication module such as a multi-channel RF module. That is, the first communication module 111 simultaneously transmits the control command to the plurality of communication modules 121a, 121b, . . . 121n respectively connected to the home appliances 120a, 120b, . . . 120n, or transmits the control command only to the communication modules 121a, 121b, . . . 121n corresponding to the selected channel.

The home server 110 controls the communication method between the first communication module 111 and the communication modules 121a, 121b, . . . 121n. According to the selection of the user, the control command may be transmitted to all the home appliances 120a, 120b, . . . 120n, or to the home appliances that the user desired to operate. That is, the user presets the desired communication method by the home server 110, so that the home server 110 controls the first communication module 111 according to the communication method preset by the user. If it is preset that the control command is transmitted to the selected home appliances, the home server 110 selects the channel corresponding to the communication module of the selected home appliance, and transmits the control command to the selected home appliance by the selected channel. For example, if the user selects the operation of the washing machine 120a, the home server 110 selects the channel corresponding to the second communication module 121a, and transmits the control command to the second communication module 121a by the selected channel. Then, the second communication module 121a transmits the control command to the washing machine 120a. At this time, the communication modules 121a, 121b, . . . 121n respectively have the different channels, whereby the control command is transmitted to the home appliance selected by the user.

Third embodiment

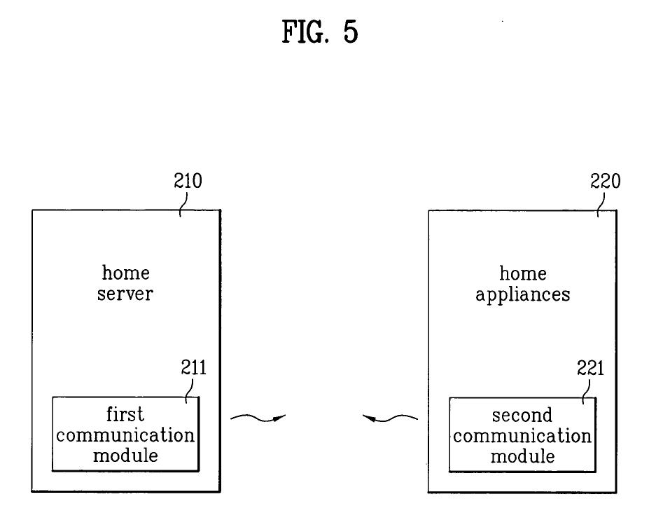

FIG. 5 is a block diagram illustrating a home network system according to the third embodiment of the present invention. As shown in FIG. 5, the home network system according to the third embodiment of the present invention includes a home server 210, an home appliance 220, a first communication module 211 mounted inside the home server 210, and a second communication module 221 mounted inside the home appliance 220.

The first and second communication modules 211 and 221 are the same wireless communication modules as those in the home network system according to the first embodiment of the present invention. At this time, the first and second communication modules 211 and 221 are respectively mounted inside the home server 210 and the home appliance 220. Also, the first communication module 211 is directly connected with a microprocessor (not shown) of the home server 210, and the second communication module 221 is directly connected with a microprocessor (not shown) of the home appliance 220.

As mentioned above, the home network system according to the present invention has the following advantages.

In the home network system according to the present invention, the home server is communicated with the home appliances so as to control them by wireless. In this respect, it is not required to provide the cable for communication between the home server and the home appliances, whereby it is possible to decrease limitations in the communication range between the home server and the home appliances, and to freely change positions of the home appliances.

Also, the home server provides the select screen from which the user selects the desired function of the home appliance, and the reservation screen for the reservation function, thereby effectively controlling the home appliances.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A home network system comprising:
a home server controlling home appliances;
a first wireless communication means connected to the home server; and
a second wireless communication means connected to the home appliances, communicating with the first wireless communication means.

2. The home network system as claimed in claim I, wherein the home server is connected with the first wireless communication means by cable.

3. The home network system as claimed in claim 2, wherein the cable is RS-232C cable.

4. The home network system as claimed in claim 1, wherein the home appliances are connected with the second wireless communication means by cable.

5. The home network system as claimed in claim 4, wherein the cable is RS-232C cable.

6. The home network system as claimed in claim 1, wherein the first and second wireless communication means are RF (Radio Frequency) communication modules.

7. The home network system as claimed in claim 1, wherein the home server displays a select screen showing functions of the home appliances.

8. The home network system as claimed in claim 1, wherein the home server provides the select screen showing functions of the home appliances to an external terminal.

9. The home network system as claimed in claim 1, wherein the home server stores a record regarding operations of the home appliances.

10. The home network system as claimed in claim 9, wherein the record regarding operations of the home appliances includes a driving time and mode of the home appliance, and power consumption.

11. The home network system as claimed in claim 1, wherein the home server has a reservation function of operating the home appliance at a preset time.

12. The home network system as claimed in claim 1, wherein the first and second wireless communication means have frequency band between 300 MHz and 2.9 GHz.

13. The home network system as claimed in claim 1, wherein the home server controls a channel of the first wireless communication means.

14. The home network system as claimed in claim 1, wherein the first wireless communication means is mounted inside the home server.

15. The home network system as claimed in claim 1, wherein the second wireless communication means is mounted inside the home appliance.

16. The home network system as claimed in claim 1, wherein the second wireless communication means respectively connected to the home appliances have different channels.
